(19) United States
(12) Patent Application Publication
(10) Pub. No.: US 2012/0209903 A1
(43) Pub. Date: Aug. 16, 2012

(54) METHOD, SYSTEM AND COMPUTER PROGRAM PRODUCT FOR EXTENSIBLE SERVICE REGISTRY FOR SERVICE ORIENTED ARCHITECTURE ENDPOINTS

(75) Inventor: Daniel Ian Salt, Colchester (GB)

(73) Assignee: General Electric Company

(21) Appl. No.: 13/026,792

(22) Filed: Feb. 14, 2011

(51) Int. Cl. G06F 15/16

(52) U.S. Cl. 709/203

(57) ABSTRACT

Described herein are embodiments of a method, system and computer program product for allocating a service to a client using an extensible service registry in a service oriented architecture (SOA). In accordance with one aspect, a method of allocating a service in a SOA includes registering one or more services with a service registry of a SOA; receiving by the service registry a query for a service, wherein the query comprises a queried service method name and one or more queried context attributes of the service; and determining by the service registry a service endpoint reference for the queried service using the queried service method name and the one or more queried context attributes of the service.

### CROSS-REFERENCE TO RELATED APPLICATION

This application is related to U.S. patent application Ser. No. ______ [GE Docket No. 245009], filed on Feb. 14, 2011, which is fully incorporated herein by reference and made a part hereof.

### BACKGROUND OF THE INVENTION

Service-oriented architecture (SOA) is a flexible set of design principles used during the phases of systems development and integration. A deployed SOA-based architecture provides a loosely-integrated suite of services that can be used within multiple business domains. Specifically, SOA embodies at least some of the characteristics of implementation independence, service reusability, loose coupling, service abstraction, and service composability.

Implementation independence refers to keeping services as implementation neutral as possible in order to facilitate maximum reusability. Service reusability refers to the goal of SOA to form applications that are built almost entirely from existing software services. Each service provides certain functionality, the larger the function is, the fewer the interface points are required. However, very large functionality may result in services that are not granular enough to be easily reused. The key is that there are no interactions between functions specified within the service. Loose coupling is a principle about interfaces having minimal assumptions between the sending and receiving parities. This reduces the risk that a change in one module will force a change in another module. Loose coupling means multiple dimensions. For the purpose of service contract, this principle focuses on using canonical model to decouple the service input output from proprietary data models. It also focuses on separating business logic from integration logic. Message routing, data transformation, integration patterns, and other integration related functions are handled by a software services infrastructure (SSI) so that services are decoupled from the underlying systems. Service abstraction refers to the relationship between a service and its underlying implementation. The right level of service abstraction is key to remove point to point interfaces. For example, advanced metering infrastructure (AMI) integration requires knowledge about meters and end devices. A service can be easily defined based on such information. The implication is that each consuming parties needs to understand the meters and end devices which requires data synchronization efforts for them to be synchronized with AMI system. An entity can have many products that need to interface with AMI data. Rather than providing a point to point interface between the products and the AMI data, a service defined on a more abstracted level, premise level, allows each individual system to have the knowledge about meters and end devices. A common component can be built to handle the relationship between premises and meters so that such integration and data synchronization only needs to be built once. The purpose of composability is to support service composition and orchestration so that new applications and processes can be built on top of existing services. Although this principle is related to service reusability and loose coupling, it provides extra guidelines for service identification. Each service should have a clear definition for its function and purpose so that it can be registered with a clear service semantics and ready for discovering. Redundant services should be avoided. No matter whether or not immediate composition requirements are already in existence, service composability should be considered for maximizing opportunity for service composition and orchestration.

Service implementations in a SOA are associated with a physical network location. Generally, these locations are described using a transport-based “address” (e.g. an HTTP URL, a JMS destination, and the like). Further, service registries in a SOA are used to logically associate a service implementation with its physical location, but heretofore have been specific to a particular transport or access scheme. For example a UDDI (Universal Data Directory Interface) is used to store Web Services URLs and, as such is a Web Services “Service Registry.” Similarly, Java-based services can be stored in an OSGi container and, as such, comprises an OSGi service registry.

Therefore, what is desired is an extensible service registry that overcomes challenges in the art, some of which are described above. In particular, a service registry is desired that does not impose any restriction on the types of location (EPR) Endpoint References that can be stored and retrieved.

### BRIEF DESCRIPTION OF THE INVENTION

In general, embodiments of the present invention provide an improvement by, among other things, providing a method, system and computer program product for allocating a service to a client using an extensible service registry in a service oriented architecture (SOA).

In accordance with one aspect, a method is provided of allocating a service in a SOA. In one embodiment, the method includes: (1) registering one or more services with a service registry of a SOA; (2) receiving by the service registry a query for a service, wherein the query comprises a queried service method name and one or more queried context attributes of the service; and (3) determining by the service registry a service endpoint reference for the queried service using the queried service method name and the one or more queried context attributes of the service.

In accordance with another aspect, a system is provided for allocating a service in a SOA. In one embodiment, the system includes: (1) a service registry comprised of a memory and a processor, wherein said processor is configured to register one or more services of a SOA in the memory; receive a query for a service, wherein the query comprises a queried service method name and one or more queried context attributes of the service; and determine a service endpoint reference for the queried service using the queried service method name and the one or more queried context attributes of the service.

In accordance with yet another aspect, a computer program product is provided for allocating a service in a SOA. The computer program product contains at least one computer-readable storage medium having computer-readable program code portions stored therein. The computer-readable program code portions of one embodiment include: (1) a first section for registering one or more services with a service registry of a SOA comprising storing in the service registry a service method name for each service of the one or more services, associating one or more service endpoint references with each service method name, and associating one or more context attributes with each service endpoint reference; (2) a second section for receiving by the service registry a query for a service, wherein the query comprises a queried service method name and one or more queried context attributes of the service; and (3) a third section for determining by the service registry a service endpoint reference for the queried service using the queried service method name and the one or more queried context attributes of the service comprising comparing the queried service method name to each service method name stored in the service registry, selecting one or more service method names of the one or more services stored in the service registry based upon the comparison, selecting one of the selected one or more service method names based on comparing the one or more queried context attributes to the one or more context attributes of the selected one or more service method names, and selecting the service endpoint reference of the selected one of the selected one or more service method names.

Additional advantages will be set forth in part in the description which follows or may be learned by practice. The advantages will be realized and attained by means of the elements and combinations particularly pointed out in the appended claims. It is to be understood that both the foregoing general description and the following detailed description are exemplary and explanatory only and are not restrictive, as claimed.

### BRIEF DESCRIPTION OF THE DRAWINGS

The accompanying drawings, which are incorporated in and constitute a part of this specification, illustrate embodiments and together with the description, serve to explain the principles of the methods and systems:

FIG. 1 illustrates an overview of one embodiment of a system for allocating a service in a service-oriented architecture (SOA);

FIG. 2 illustrates an exemplary data structure for a service registry according to an aspect of the present invention;

FIG. 3 is a block diagram illustrating an exemplary operating environment for performing the disclosed methods;

FIG. 4 illustrates an exemplary flowchart of performing the steps of an embodiment a method of allocating a service in a service oriented architecture (SOA); and

FIG. 5 illustrates an exemplary flowchart of performing the steps of another embodiment a method of allocating a service in a service-oriented architecture (SOA).

### DETAILED DESCRIPTION OF THE INVENTION

Before the present methods and systems are disclosed and described, it is to be understood that the methods and systems are not limited to specific synthetic methods, specific components, or to particular compositions. It is also to be understood that the terminology used herein is for the purpose of describing particular embodiments only and is not intended to be limiting.

As used in the specification and the appended claims, the singular forms “a,” “an” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other additives, components, integers or steps. “Exemplary” means “an example of” and is not intended to convey an indication of a preferred or ideal embodiment. “Such as” is not used in a restrictive sense, but for explanatory purposes.

Disclosed are components that can be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all aspects of this application including, but not limited to, steps in disclosed methods. Thus, if there are a variety of additional steps that can be performed it is understood that each of these additional steps can be performed with any specific embodiment or combination of embodiments of the disclosed methods.

The present methods and systems may be understood more readily by reference to the following detailed description of preferred embodiments and the Examples included therein and to the Figures and their previous and following description.

As will be appreciated by one skilled in the art, the methods and systems may take the form of an entirely hardware embodiment, an entirely software embodiment, or an embodiment combining software and hardware aspects. Furthermore, the methods and systems may take the form of a computer program product on a computer-readable storage medium having computer-readable program instructions (e.g., computer software) embodied in the storage medium. More particularly, the present methods and systems may take the form of web-implemented computer software. Any suitable computer-readable storage medium may be utilized including hard disks, CD-ROMs, optical storage devices, or magnetic storage devices.

Embodiments of the methods and systems are described below with reference to block diagrams and flowchart illustrations of methods, systems, apparatuses and computer program products. It will be understood that each block of the block diagrams and flowchart illustrations, and combinations of blocks in the block diagrams and flowchart illustrations, respectively, can be implemented by computer program instructions. These computer program instructions may be loaded onto a general purpose computer, special purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

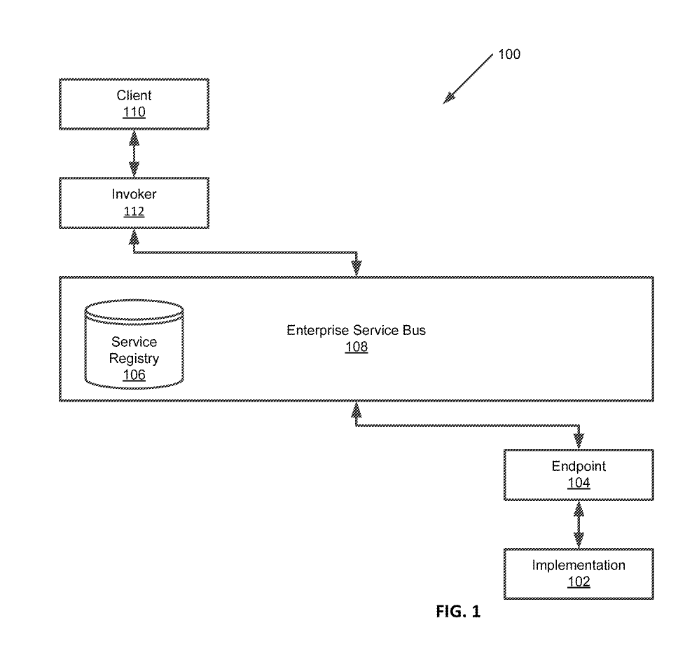

FIG. 1 illustrates an overview of one embodiment of a system for allocating a service in a service-oriented architecture (SOA) 100. As shown in FIG. 1, an implementation 102 is created in a SOA 100. An implementation 102 implements a service in the SOA 100. Non-limiting examples of services that can be implemented in the SOA 100 include a meter ping/poll service to ascertain the status of a meter from an AMI or OMS (outage management system), or a weather service, provided by an external system and accessed via the enterprise service bus (ESB).

Creation of the implementation 102 and its endpoint 104 causes registration of the endpoint reference (EPR) 104 in an embodiment of a service registry 106. The EPR 104 is a physical address on the SOA 100 assigned by a middleware application of the location of the implementation 102. The EPR 104 also “listens” on middleware applications such as the ESB 108 as shown in FIG. 1. Other examples of middleware applications include Java message service (JMS) and Web Services, among others. Registering the EPR 104 in the service registry 106 can comprise storing in a memory associated with the service registry 106 a service method name. In one aspect the service method name can be a web services description language (WSDL) name. The EPR 104 is associated with the service method name. In one aspect, multiple EPRs 104 can be associated with a single service method name. Even though the association between an EPR 104 and a service is one-to-one, multiple EPRs 104 can be associated with a single service and the service registry entries can be defined on a per-method basis or a per-service basis.

Registering the EPR 104 in the service registry 106 further comprises associating one or more context attributes with each service endpoint reference 104. The context attributes provide an extensible service registry 106. The context attributes are used to qualify a single EPR 104 to return if the service registry 106 comprises a service method name with multiple EPRs 104. In one aspect, the one or more context attributes associated with each service endpoint reference 104 can include one or more of priority, classification, version and access time, though other and additional context attributes are contemplated within the scope of embodiments of the present invention. Priority refers to an integer number from 0 upwards, where 0 (zero) is the highest priority. The EPR(s) 104 with the highest priority are generally selected. Classification refers to a textual field that “classifies” the endpoint. A classification is useful if a number of different systems implement the service, but each system implements the service in different ways. For example, classifications may include “Study,” “Source,” “Calculated.” Another example can be multiple vendors implementing the same service. In this instance, the classification might be called “system” and have exemplary values of “SSN,” “Gridnet,” “GE,” and the like. Typically, business or operational-level decisions will determine how each instance is classified: Areas of Responsibility, Time of Day, owning system/region, accuracy, compliance, and the like. Classifications allow embodiments of the invention to maintain a Canonical Service Model without directly modifying the service interface to each end system to differentiate it at runtime. The EPR(s) 104 that match a given classification are generally returned. Version refers to a field that defines a version. The field is an expression, since the caller could require “exactly the version,” “at least this version,” or “at most this version.” The EPR(s) 104 that match the expression are generally returned. Access Time refers to a field that states the access time for this service. This field can be configured to show the average, last or best access time for the request.

The technical effect of embodiments described herein provide an extensible service registry that benefits and improves a software services infrastructure by making the infrastructure readily scalable and increasing the granularity of EPR selection by the use of context attributes.

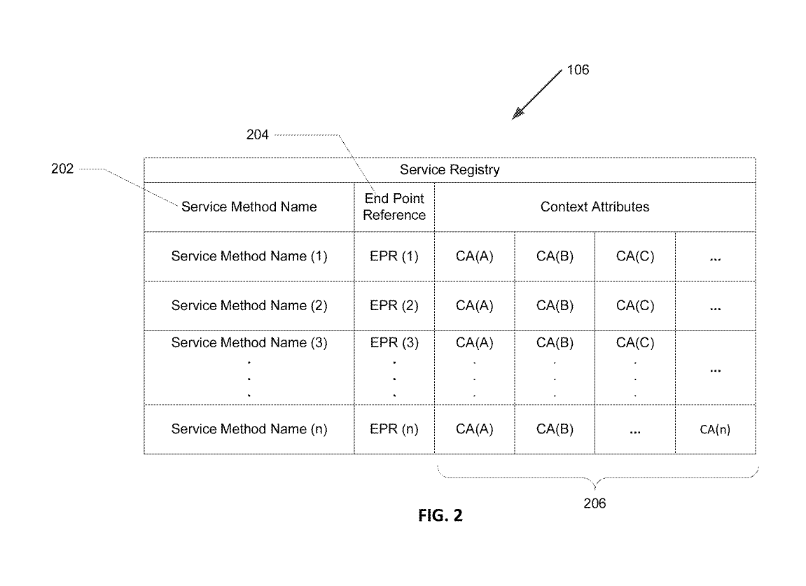

FIG. 2 illustrates an exemplary data structure for a service registry 106 according to an aspect of the present invention. As shown in FIG. 2, a single service method name 202 can be associated with one or more end point references 204. Likewise, each end point reference 204 can be associated with one or more context attributes 206. The shown exemplary structure allows a service method name 202 that is associated with multiple EPRs 204 to be filtered to a single EPR 204 based upon the context attributes 206. The exemplary design of the service registry data structure as shown in FIG. 2 allows any number of context attributes 206 to be declared and compared at runtime. A client can choose whether to declare the context attributes 206, or not, when making a query against the service registry 106.

Returning to FIG. 1, when a client 110 invokes a service, the client 110, through the use of an associated invoker 112, issues a query command to the service registry 106. The query comprises the desired service method name and any optional context attributes 206 that can be used by the service registry 106 to qualify the EPR 104. Upon receipt of the query, the service registry 106 uses the information passed in the query to determine an EPR 104 to return to the client 110. In one aspect, if the desired service cannot be identified by the service registry 106 based upon the received query parameters, the service registry 106 may not return an EPR 104 to the client 110.

As shown in FIG. 1, in one aspect the service registry 106 is designed to function as a component within a middleware application such as an ESB 108 (e.g. as an embedded Java component, OSGi Bundle, EJB, etc). However, in other aspects the service registry 106 may act as a standalone application communicating via a wire protocol such as HTTP, JMS, etc. On creation of an implementation 102, the service registry 106 initializes its repository (e.g., the data structure as shown in FIG. 2). As noted herein, the service registry 106 can use the WSDL names for a given service method as the mapping identifier. WSDL names can be used because they already exist and are an accepted industry format, they are automatically generated for all WSDL-to-Java created content, and they include a unique qualified name (namespace and method name). Because of the data structure of the service registry 106, mappings are stored at method-level rather than service-level and implementations 102 do not have to implement all methods of a service. By storing mappings at a method level, the target system will only be referenced for that particular method. Requests for other methods in the same service (that were not registered) will not have a reference to the same target system. Because of this, the target system does not have to provide an implementation.

FIG. 1 illustrates an exemplary flow of execution for a client 110 using an embodiment of the service registry 106. The invoker 112 and endpoint 104 components are associated with a client 110 and implementation 102, respectively and are responsible for communicating to/from software services infrastructure (SSI) components (such as the service registry 106) on an ESB 108. Generally, a service registry 106 is a component that provides decoupling of a service invoker 112, and the EPR 104 that receives service requests from the invoker 112. Generally, the service registry 106 comprises two parts, a static part (known as a service catalog), and a dynamic part (known as a runtime registry). An exemplary software services infrastructure (SSI) can comprise an application layer, an integration layer, one or more systems, and security components. In the context of an embodiment of a SSI, a “system” refers to another functional system, either providing or consuming data from the SSI. Systems can be, for example, data-stores, applications, analytics, etc. Examples of such systems include products, third-party systems, databases, and business processes. In one aspect, the SSI interacts with these end systems via data adapters, which may be specifically created for the SSI, or may be standard components that are included as part of the underlying infrastructure, or provided by third parties.

In one aspect, a service catalog stores static information about a service. Similar to a federated model as known to one of ordinary skill in the art, a service catalog is shared across all SSI instances that share the same set of services for a particular deployment. Static information can include: service name—the name of the service, typically represented as an HTTP URL (as created by, for example, the JAX-WS/JAX-B WSDL tools); service roles—the security roles associated with a particular service such that a requestor must have permission to these roles in order to execute the service; service classifications or context attributes—one or more extensible fields that allow any additional key/value pairs to be associated with the service name. Typical usage of this field could be to store, for example, the target system, the accuracy of the data, etc. A client application can optionally specify one or more classifications to resolve a service. The service registry can also be configured to define a set of default system classifications for all clients, or an individual client can define a set of default classifications to be used for all services in that context. In one aspect, a runtime registry stores dynamic information associated with a service. It is local to a single SSI deployed instance, and stores, for example: one or more endpoint reference(s) associated with the service for a particular SSI instance. An endpoint reference is unique to a particular SSI, and refers to a location for the service. This can be done using, for example, a JMS reference, local bean references, OSGi Service Registry entries, HTTP URL's, etc.; service runtime data—similar to the service classifications or context attributes in the static part, the runtime registry can store optional additional attributes for the runtime data for a particular service. Typical usage of this field can be to store, for example, time taken for the previous invocation, health (ping) information, etc. While logically the same as context attributes, service runtime data are runtime-specific, and are not persisted in the catalog. They are typically fields that change during the lifetime of the system; Priority—used to determine, when presented with multiple matches for a given service, which endpoint reference to return. The service with the highest priority wins; and, client identifier—used to determine, when necessary, the client system in which this endpoint is registered. An endpoint is registered in a client typically to implement callbacks, where the callback message is delivered to a particular client.

In one aspect, the invoker 112 for the service registry 106 further comprises an EPR cache. When an EPR 104 is obtained for a particular service, the result can be stored in the invoker EPR cache. The next time the EPR 104 is requested for the method, the result is returned from the cache. The EPR cache can be configured for the amount of time that a particular reference is held before it is removed. In one aspect, the EPR cache also contains a listener for service registry events, which are sent by the service registry 106 component when the registry information changes for a particular EPR 104, so that the cache entry can be invalidated. In one aspect, each service has its own channel on an events stream, so that the service registry invoker 112 for a particular client 110 only receives events for services that it has stored in its invoker EPR cache.

Returning to FIG. 1, when a client 110 receives an EPR 104 returned from the service registry 106, the invoker 112 (of the client 110) then sends a request for the desired service to the returned EPR 104, where the request is received and processed by the EPR 104 (and subsequently the implementation 102). Similar logic also applies in a publish-subscribe MEP (Message Exchange Pattern). A publisher registers its event EPR to which it will publish messages (typically a JMS Topic). The subscriber uses the service registry to look-up the correct EPR and establish an ESB (or other middleware application) route for delivering messages from that EPR to the subscriber.

In one aspect, embodiments of a service registry 106 as described herein provide a system for allocating a service in a service-oriented architecture (SOA). The exemplary system is comprised of a service registry 106, which, in one aspect, is further comprised of a memory and a processor. In one aspect, the processor is configured to register one or more services of a service oriented architecture (SOA) in the memory; receive a query for a service, wherein the query comprises a queried service method name and one or more queried context attributes of the service; and determine a service endpoint reference 104 for the queried service using the queried service method name and the one or more queried context attributes of the service. In one aspect, further comprising the described embodiment of a system is a requesting client 110, wherein the service endpoint reference 104 is returned to the requesting client 110, and the requesting client 110 sends a request for implementation of the service to the service endpoint reference 104. The query is sent to the service registry 106, and the EPR 104 is returned to the requesting client 110 via one or more middleware applications, such as an enterprise service bus 108. Other middleware service applications can include Java message service (JMS) or Web Services. As described herein, the service endpoint reference 104 is a physical address provided by the one or more middleware applications.

As described herein, the processor is configured to register the one or more services of the SOA with the service registry 106. In one aspect, this comprises the processor configured to store in the memory of the service registry 106 a service method name for each service of the one or more services; associate one or more service endpoint references with each service method name; and associate one or more context attributes with each service endpoint reference. One embodiment of a structure showing these relationships is illustrated in FIG. 2. In one aspect, the middleware application can comprise an ESB 108, and because an ESB 108 is typically used in a clustered and/or fault-tolerant topology, the information stored in the service registry 106 can be distributed across multiple physical ESB 108 instances. Therefore, the service registry 106 can leverage commercial distributed cache technology as its storage mechanism (i.e., its memory). A distributed cache can consist of many nodes that share the same information. In one aspect, when an entry is made in the service registry 106, it is propagated to the other nodes in the same cache.

As described herein, the processor of the service registry 106 is configured to determine a service endpoint reference for the queried service using the queried service method name and the queried one or more context attributes of the service. In one aspect, this comprises the processor configured to compare the queried service method name to each service method name stored in the memory of the service registry 106; select one or more service method names of the one or more services stored in the memory based upon the comparison; select one of the selected one or more service method names based on comparing the one or more queried context attributes to the one or more context attributes of the selected one or more service method names; and select the service endpoint reference 104 of the selected one of the selected one or more service method names. As described herein, in one aspect the one or more context attributes associated with each service endpoint reference 104 can include one or more of priority, classification, version and access time. Also, as described herein, the service method name can comprise a web services description language (WSDL) name.

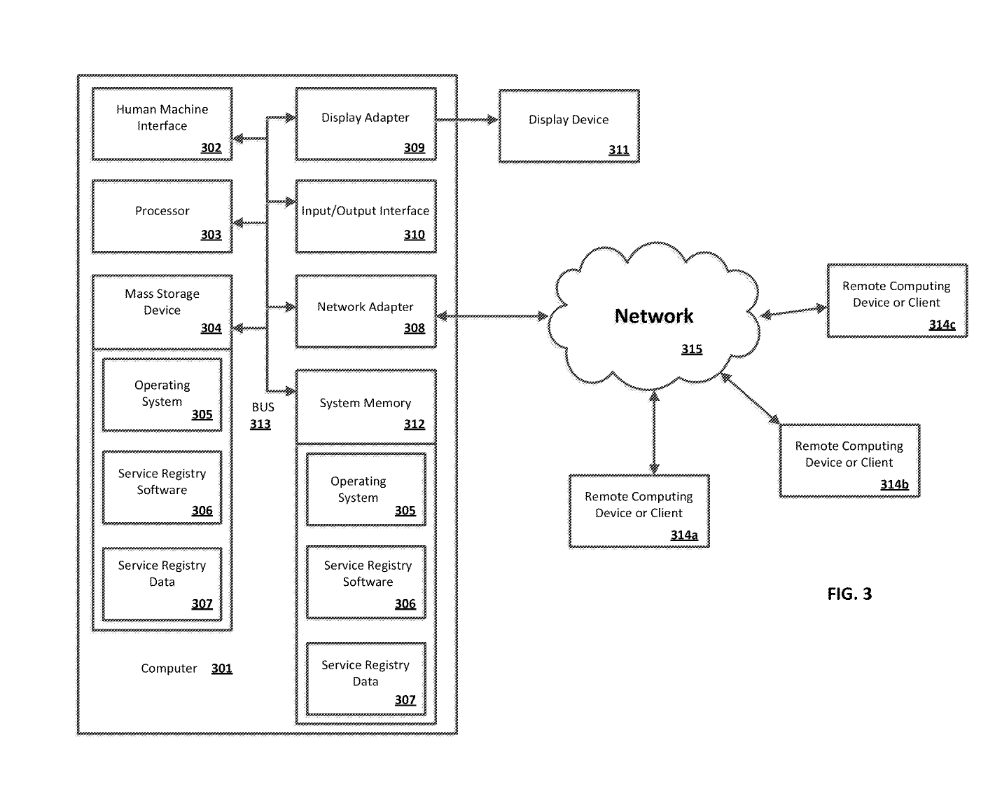

The above system (e.g., the service registry 106 and the components of the SOA 100) has been described above as comprised of units. One skilled in the art will appreciate that this is a functional description and that software, hardware, or a combination of software and hardware can perform the respective functions. A unit, such as a service registry, can be software, hardware, or a combination of software and hardware. The units can comprise the service registry software 306 as illustrated in FIG. 3 and described below. In one exemplary aspect, the units can comprise a computer 301 as illustrated in FIG. 3 and described below.

FIG. 3 is a block diagram illustrating an exemplary operating environment for performing the disclosed methods. This exemplary operating environment is only an example of an operating environment and is not intended to suggest any limitation as to the scope of use or functionality of operating environment architecture. Neither should the operating environment be interpreted as having any dependency or requirement relating to any one or combination of components illustrated in the exemplary operating environment.

The present methods and systems can be operational with numerous other general purpose or special purpose computing system environments or configurations. Examples of well known computing systems, environments, and/or configurations that can be suitable for use with the systems and methods comprise, but are not limited to, personal computers, server computers, laptop devices, and multiprocessor systems. Additional examples comprise set top boxes, programmable consumer electronics, network PCs, minicomputers, mainframe computers, smart meters, smart-grid components, distributed computing environments that comprise any of the above systems or devices, and the like.

The processing of the disclosed methods and systems can be performed by software components. The disclosed systems and methods can be described in the general context of computer-executable instructions, such as program modules, being executed by one or more computers or other devices. Generally, program modules comprise computer code, routines, programs, objects, components, data structures, etc. that perform particular tasks or implement particular abstract data types. The disclosed methods can also be practiced in grid-based and distributed computing environments where tasks are performed by remote processing devices that are linked through a communications network. In a distributed computing environment, program modules can be located in both local and remote computer storage media including memory storage devices.

Further, one skilled in the art will appreciate that the systems and methods disclosed herein can be implemented via a general-purpose computing device in the form of a computer 301. The components of the computer 301 can comprise, but are not limited to, one or more processors or processing units 303, a system memory 312, and a system bus 313 that couples various system components including the processor 303 to the system memory 312. In the case of multiple processing units 303, the system can utilize parallel computing.

The system bus 313 represents one or more of several possible types of bus structures, including a memory bus or memory controller, a peripheral bus, an accelerated graphics port, and a processor or local bus using any of a variety of bus architectures. By way of example, such architectures can comprise an Industry Standard Architecture (ISA) bus, a Micro Channel Architecture (MCA) bus, an Enhanced ISA (EISA) bus, a Video Electronics Standards Association (VESA) local bus, an Accelerated Graphics Port (AGP) bus, and a Peripheral Component Interconnects (PCI), a PCI-Express bus, a Personal Computer Memory Card Industry Association (PCMCIA), Universal Serial Bus (USB) and the like. The bus 313, and all buses specified in this description can also be implemented over a wired or wireless network connection and each of the subsystems, including the processor 303, a mass storage device 304, an operating system 305, service registry software 306, service registry data 307, a network adapter 308, system memory 312, an Input/Output Interface 310, a display adapter 309, a display device 311, and a human machine interface 302, can be contained within one or more remote computing devices or clients 314a,b,c at physically separate locations, connected through buses of this form, in effect implementing a fully distributed system or distributed architecture.

The computer 301 typically comprises a variety of computer readable media. Exemplary readable media can be any available media that is non-transitory and accessible by the computer 301 and comprises, for example and not meant to be limiting, both volatile and non-volatile media, removable and non-removable media. The system memory 312 comprises computer readable media in the form of volatile memory, such as random access memory (RAM), and/or non-volatile memory, such as read only memory (ROM). The system memory 312 typically contains data such as service registry data 307 and/or program modules such as operating system 305 and service registry software 306 that are immediately accessible to and/or are presently operated on by the processing unit 303.

In another aspect, the computer 301 can also comprise other non-transitory, removable/non-removable, volatile/non-volatile computer storage media. By way of example, FIG. 3 illustrates a mass storage device 104 that can provide non-volatile storage of computer code, computer readable instructions, data structures, program modules, and other data for the computer 301. For example and not meant to be limiting, a mass storage device 304 can be a hard disk, a removable magnetic disk, a removable optical disk, magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like.

Optionally, any number of program modules can be stored on the mass storage device 304, including by way of example, an operating system 305 and service registry software 306. Each of the operating system 305 and service registry software 306 (or some combination thereof) can comprise elements of the programming and the service registry software 306. Service registry data 307 can also be stored on the mass storage device 304. Service registry data 307 can be stored in any of one or more databases known in the art. Examples of such databases comprise, DB2®, Microsoft® Access, Microsoft® SQL Server, Oracle®, mySQL, PostgreSQL, and the like. The databases can be centralized or distributed across multiple systems.

In another aspect, the user can enter commands and information into the computer 301 via an input device (not shown). Examples of such input devices comprise, but are not limited to, a keyboard, pointing device (e.g., a “mouse”), a microphone, a joystick, a scanner, tactile input devices such as gloves, and other body coverings, and the like These and other input devices can be connected to the processing unit 303 via a human machine interface 302 that is coupled to the system bus 313, but can be connected by other interface and bus structures, such as a parallel port, game port, an IEEE 1394 Port (also known as a Firewire port), a serial port, or a universal serial bus (USB).

In yet another aspect, a display device 311 can also be connected to the system bus 313 via an interface, such as a display adapter 309. It is contemplated that the computer 301 can have more than one display adapter 309 and the computer 301 can have more than one display device 311. For example, a display device can be a monitor, an LCD (Liquid Crystal Display), or a projector. In addition to the display device 311, other output peripheral devices can comprise components such as speakers (not shown) and a printer (not shown), which can be connected to the computer 301 via Input/Output Interface 310. Any step and/or result of the methods can be output in any form to an output device. Such output can be any form of visual representation, including, but not limited to, textual, graphical, animation, audio, tactile, and the like.

The computer 301 can operate in a networked environment using logical connections to one or more remote computing devices or clients 314a,b,c. By way of example, a remote computing device can be a personal computer, portable computer, a server, a router, a network computer, a peer device or other common network node, and so on. Logical connections between the computer 301 and a remote computing device or client 314a,b,c can be made via a local area network (LAN) and a general wide area network (WAN). Such network connections can be through a network adapter 308. A network adapter 308 can be implemented in both wired and wireless environments. Such networking environments are conventional and commonplace in offices, enterprise-wide computer networks, intranets, and other networks 315 such as the Internet.

For purposes of illustration, application programs and other executable program components such as the operating system 305 are illustrated herein as discrete blocks, although it is recognized that such programs and components reside at various times in different storage components of the computing device 301, and are executed by the data processor(s) of the computer. An implementation of service registry software 306 can be stored on or transmitted across some form of computer readable media. Any of the disclosed methods can be performed by computer readable instructions embodied on computer readable media. Computer readable media can be any available media that can be accessed by a computer. By way of example and not meant to be limiting, computer readable media can comprise “computer storage media” and “communications media.” “Computer storage media” comprise volatile and non-volatile, removable and non-removable media implemented in any methods or technology for storage of information such as computer readable instructions, data structures, program modules, or other data. Exemplary computer storage media comprises, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

The methods and systems can employ Artificial Intelligence techniques such as machine learning and iterative learning. Examples of such techniques include, but are not limited to, expert systems, case based reasoning, Bayesian networks, behavior based AI, neural networks, fuzzy systems, evolutionary computation (e.g. genetic algorithms), swarm intelligence (e.g. ant algorithms), and hybrid intelligent systems (e.g. Expert inference rules generated through a neural network or production rules from statistical learning).

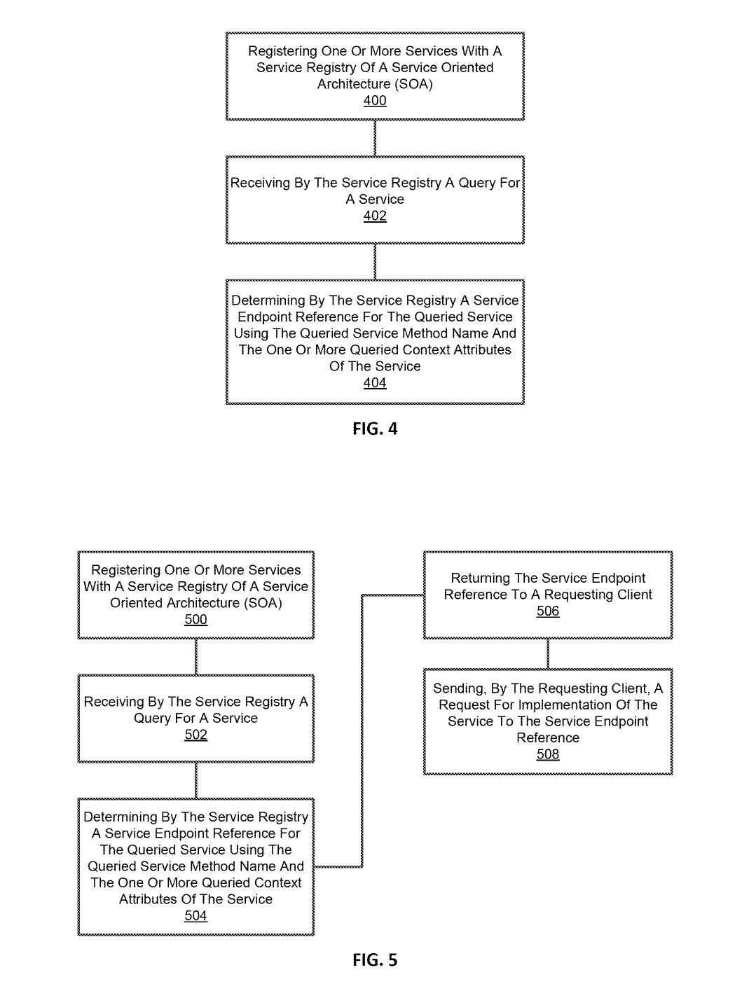

As noted above, FIG. 3 is a block diagram illustrating an exemplary operating environment for performing methods of allocating a service in a service-oriented architecture (SOA). FIG. 4 illustrates an exemplary flowchart of performing the steps of an embodiment a method of allocating a service in a service-oriented architecture (SOA). Step 400 comprises registering one or more services with a service registry of a service oriented architecture (SOA). In one aspect, registering the one or more services with the service registry of the SOA comprises storing in the service registry a service method name for each service of the one or more services; associating one or more service endpoint references with each service method name; and associating one or more context attributes with each service endpoint reference. In one aspect, the one or more context attributes associated with each service endpoint reference include one or more of priority, classification, version and access time, as described herein. In one aspect, the service method name comprises a web services description language (WSDL) name. Step 402 comprises receiving by the service registry a query for a service, wherein the query comprises a queried service method name and one or more queried context attributes of the service. As noted above, the service registry can be implemented on a computing device such as the computer 301 shown in FIG. 3. In one aspect, the query is received by the service registry via a middleware application such as an ESB, Java message service (JMS), or Web Services. Step 404 comprises determining by the service registry a service endpoint reference for the queried service using the queried service method name and the one or more queried context attributes of the service. In one aspect, determining by the service registry a service endpoint reference for the queried service using the queried service method name and the queried one or more context attributes of the service comprises comparing the queried service method name to each service method name stored in the service registry; selecting one or more service method names of the one or more services stored in the service registry based upon the comparison; selecting one of the selected one or more service method names based on comparing the one or more queried context attributes to the one or more context attributes of the selected one or more service method names; and selecting the service endpoint reference of the selected one of the selected one or more service method names.

FIG. 5 illustrates an exemplary flowchart of performing the steps of another embodiment a method of allocating a service in a service-oriented architecture (SOA). Steps 500, 502 and 504 are the same as Steps 400, 402 and 404 of FIG. 4. Step 506 comprises returning the service endpoint reference to a requesting client, and Step 508 comprises sending, by the requesting client, a request for implementation of the service to the service endpoint reference. In one aspect, the service endpoint reference is returned to the requesting client via the middleware application (e.g., ESB, JMS, or Web Services).

### EXAMPLES

The following examples are put forth so as to provide those of ordinary skill in the art with a complete disclosure and description of how the compounds, compositions, articles, devices and/or methods claimed herein are made and evaluated, and are intended to be purely exemplary and are not intended to limit the scope of the methods and systems. Efforts have been made to ensure accuracy with respect to numbers, but some errors and deviations should be accounted for.

In one example, embodiments of a service registry or catalog as described herein provide an intrinsic part of a SSI. Though it can be used standalone, much of the meta-data on which it relies is currently only provided by SSI. Uses of such an SSI incorporating embodiments of the described service registry include for example smart grid and total plant optimization (TPO) applications.

While the methods and systems have been described in connection with preferred embodiments and specific examples, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

Throughout this application, various publications are referenced. The disclosures of these publications in their entireties are hereby incorporated by reference into this application in order to more fully describe the state of the art to which the methods and systems pertain.

It will be apparent to those skilled in the art that various modifications and variations can be made without departing from the scope or spirit. Other embodiments will be apparent to those skilled in the art from consideration of the specification and practice disclosed herein. It is intended that the specification and examples be considered as exemplary only, with a true scope and spirit being indicated by the following claims.

What is claimed is:

1. A method of allocating a service in a service oriented architecture (SOA) comprising:
registering one or more services with a service registry of a service oriented architecture (SOA);
receiving by the service registry a query for a service, wherein the query comprises a queried service method name and one or more queried context attributes of the service; and
determining by the service registry a service endpoint reference for the queried service using the queried service method name and the one or more queried context attributes of the service.

2. The method of claim 1 further comprising:
returning the service endpoint reference to a requesting client; and
sending, by the requesting client, a request for implementation of the service to the service endpoint reference.

3. The method of claim 2, wherein the query is received by the service registry via a middleware application and the service endpoint reference is returned to the requesting client via the middleware application.

4. The method of claim 3, wherein the middleware application includes enterprise service bus (ESB), Java message service (JMS), or Web Services.

5. The method of claim 3, wherein the service endpoint reference is a physical address provided by the middleware application.

6. The method of claim 1, wherein registering the one or more services with the service registry of the SOA comprises:
storing in the service registry a service method name for each service of the one or more services;
associating one or more service endpoint references with each service method name; and
associating one or more context attributes with each service endpoint reference.

7. The method of claim 6, wherein determining by the service registry a service endpoint reference for the queried service using the queried service method name and the queried one or more context attributes of the service comprises:
comparing the queried service method name to each service method name stored in the service registry;
selecting one or more service method names of the one or more services stored in the service registry based upon the comparison;
selecting one of the selected one or more service method names based on comparing the one or more queried context attributes to the one or more context attributes of the selected one or more service method names; and
selecting the service endpoint reference of the selected one of the selected one or more service method names.

8. The method of claim 7 further comprising:
returning the selected service endpoint reference to a requesting client; and
sending, by the requesting client, a request for implementation of the service to the selected service endpoint reference.

9. The method of claim 6, wherein the one or more context attributes associated with each service endpoint reference include one or more of priority, classification, version and access time.

10. The method of claim 6, wherein the service method name comprises a web services description language (WSDL) name.

11. A system for allocating a service in a service oriented architecture (SOA) comprised of:
a service registry, said service registry comprised of a memory and a processor, wherein said processor is configured to,
register one or more services of a service oriented architecture (SOA) in the memory;
receive a query for a service, wherein the query comprises a queried service method name and one or more queried context attributes of the service; and
determine a service endpoint reference for the queried service using the queried service method name and the one or more queried context attributes of the service.

12. The system of claim 11 further comprising a requesting client, wherein the service endpoint reference is returned to the requesting client, and the requesting client sends a request for implementation of the service to the service endpoint reference.

13. The system of claim 12 further comprising one or more middleware applications, wherein the query is received by the service registry via the one or more middleware applications and the service endpoint reference is returned to the requesting client via the one or more middleware applications, said service endpoint reference is a physical address provided by the one or more middleware applications.

14. The system of claim 13, wherein the one or more middleware applications include enterprise service bus (ESB), Java message service (JMS), or Web Services.

15. The system of claim 11, wherein the processor configured to register the one or more services of the SOA further comprises the processor configured to:
store in the memory a service method name for each service of the one or more services;
associate one or more service endpoint references with each service method name; and
associate one or more context attributes with each service endpoint reference.

16. The system of claim 15, wherein the processor configured to determine a service endpoint reference for the queried service using the queried service method name and the queried one or more context attributes of the service further comprises the processor configured to:
compare the queried service method name to each service method name stored in the memory;
select one or more service method names of the one or more services stored in the memory based upon the comparison;
select one of the selected one or more service method names based on comparing the one or more queried context attributes to the one or more context attributes of the selected one or more service method names; and
select the service endpoint reference of the selected one of the selected one or more service method names.

17. The system of claim 16 further comprising a requesting client, wherein the selected service endpoint reference is returned to the requesting client, and the requesting client sends a request for implementation of the service to the selected service endpoint reference.

18. The system of claim 15, wherein the one or more context attributes associated with each service endpoint reference include one or more of priority, classification, version and access time.

19. The system of claim 15, wherein the service method name comprises a web services description language (WSDL) name.

20. A computer program product comprised of computer-executable code sections stored on a non-transitory computer-readable medium, said computer-executable code sections comprising:
a first section for registering one or more services with a service registry of a service oriented architecture (SOA) comprising storing in the service registry a service method name for each service of the one or more services, associating one or more service endpoint references with each service method name, and associating one or more context attributes with each service endpoint reference;
a second section for receiving by the service registry a query for a service, wherein the query comprises a queried service method name and one or more queried context attributes of the service; and
a third section for determining by the service registry a service endpoint reference for the queried service using the queried service method name and the one or more queried context attributes of the service comprising comparing the queried service method name to each service method name stored in the service registry, selecting one or more service method names of the one or more services stored in the service registry based upon the comparison, selecting one of the selected one or more service method names based on comparing the one or more queried context attributes to the one or more context attributes of the selected one or more service method names, and selecting the service endpoint reference of the selected one of the selected one or more service method names.
